(19) United States
(12) Patent Application Publication
(10) Pub. No.: US 2026/0203505 A1
(43) Pub. Date: Jul. 16, 2026

(54) SYSTEM AND METHOD TO BUILD DYNAMIC APPLICATION PROMPTS WITH SUMMARIZATION FROM INTERACTION DATA

(71) Applicant: BANK OF AMERICA CORPORATION, Charlotte, NC (US)

(72) Inventors: Saurabh Arora, Gurugram (IN); Sandeep Kumar Chauhan, Hyderabad (IN)

(73) Assignee: BANK OF AMERICA CORPORATION, Charlotte, NC (US)

(21) Appl. No.: 19/024,275

(22) Filed: Jan. 16, 2025

(51) Int. Cl. G06F 40/30; G06N 3/045

(52) U.S. Cl. CPC G06F 40/30; G06N 3/045

(57) ABSTRACT

Systems, computer program products, and methods are described herein for building dynamic application prompts with summarization from interaction data. The present disclosure is configured to: receive an interaction between a first participant and a second participant; consolidate a set of context data associated with the interaction via a first micro language model to form a context summary; monitor the interaction for a set of interaction data via a second micro language model, wherein the set of interaction data monitored by the second micro language model forms an interaction summary via the second micro language model; generate a set of resolutions and a set of warnings associated with the received interaction based on the context summary and the interaction summary; and highlight components within the interaction based on the set of warnings and the set of resolutions.

### TECHNOLOGICAL FIELD

Example embodiments of the present disclosure relate to building dynamic application prompts within summarization from interaction data.

### BACKGROUND

Comprehending and understanding the context behind an interaction may take time and resources away from generating possible solutions for the interaction.

Applicant has identified a number of deficiencies and problems associated with building dynamic application prompts with summarizations from interaction data. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for building dynamic application prompts with summarization from interaction data. In one aspect, a system for building dynamic application prompts with summarization from interaction data is provided. The system including a processing device, a non-transitory storage device containing instructions when executed by the processing device, causes the processing device to perform the steps of: receive an interaction between a first participant and a second participant; consolidate a set of context data associated with the interaction via a first micro language model to form a context summary; monitor the interaction for a set of interaction data via a second micro language model, wherein the set of interaction data monitored by the second micro language model forms an interaction summary via the second micro language model; generate a set of resolutions and a set of warnings associated with the received interaction based on the context summary and the interaction summary; and highlight components within the interaction based on the set of warnings and the set of resolutions.

In some embodiments, highlighted components within the interaction are updated on a predetermined periodic basis during the interaction.

In some embodiments, the interaction summary may be added to the set of context data upon conclusion of the interaction.

In some embodiments, the set of context data may comprise previously conducted interactions, historical requests, and participant actions before the interaction.

In some embodiments, the set of context data within the interaction comprises indirect communication between the first participant and the second participant.

In some embodiments, the set of resolutions and the set of warnings are categorized into predetermined groups.

In some embodiments, the interaction summary may be updated on a predetermined periodic basis during the interaction.

In another aspect, a computer program product for building dynamic application prompts with summarization from interaction data is presented. The computer program product comprising at least one non-transitory computer-readable medium having computer-readable program code portions embodied therein, the computer-readable program code portions which when executed by a processing device are configured to cause the processor to perform the following operations: receive an interaction between a first participant and a second participant; consolidate a set of context data associated with the interaction via a first micro language model to form a context summary; monitor the interaction for a set of interaction data via a second micro language model, wherein the set of interaction data monitored by the second micro language model forms an interaction summary via the second micro language model; generate a set of resolutions and a set of warnings associated with the received interaction based on the context summary and the interaction summary; and highlight components within the interaction based on the set of warnings and the set of resolutions.

In some embodiments, highlighted components within the interaction are updated on a predetermined periodic basis during the interaction.

In some embodiments, the interaction summary may be added to the set of context data upon conclusion of the interaction.

In some embodiments, the set of context data may comprise previously conducted interactions, historical requests, and participant actions before the interaction.

In some embodiments, the set of context data within the interaction comprises indirect communication between the first participant and the second participant.

In some embodiments, the set of resolutions and the set of warnings are categorized into predetermined groups.

In some embodiments, the interaction summary may be updated on a predetermined periodic basis during the interaction.

In another aspect, a computer-implemented method for building dynamic application prompts with summarization from interaction data is presented. The computer-implemented method comprising: receiving an interaction between a first participant and a second participant; consolidating a set of context data associated with the interaction via a first micro language model to form a context summary; monitoring the interaction for a set of interaction data via a second micro language model, wherein the set of interaction data monitored by the second micro language model forms an interaction summary via the second micro language model; generating a set of resolutions and a set of warnings associated with the received interaction based on the context summary and the interaction summary; and highlighting components within the interaction based on the set of warnings and the set of resolutions.

In some embodiments, highlighted components within the interaction are updated on a predetermined periodic basis during the interaction.

In some embodiments, the interaction summary may be added to the set of context data upon conclusion of the interaction.

In some embodiments, the set of context data may comprise previously conducted interactions, historical requests, and participant actions before the interaction.

In some embodiments, the set of context data within the interaction comprises indirect communication between the first participant and the second participant.

In some embodiments, the set of resolutions and the set of warnings are categorized into predetermined groups.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrate technical components of an exemplary distributed computing environment for building dynamic application prompts with summarization from interaction data, in accordance with an embodiment of the disclosure;

FIG. 2 illustrates an exemplary machine learning (ML) subsystem architecture, in accordance with an embodiment of the disclosure; and

FIG. 3 illustrates a process flow for building dynamic application prompts with summarization from interaction data, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, this data may be related to the people who work for the organization, its products or services, the customers, or any other aspect of the operations of the organization. As such, the entity may be any institution, group, association, financial institution, establishment, company, union, authority, or the like, employing information technology resources for processing large amounts of data.

As described herein, a “user” may be an individual associated with an entity. As such, in some embodiments, the user may be an individual having past relationships, current relationships, or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface may include a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that may be used to identify a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure, and positioning (e.g., distal phalanges, intermediate phalanges, proximal phalanges, and the like)), an answer to a security question, a unique intrinsic user activity (e.g., making a predefined motion with a user device), and/or the like. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources input by the plurality of users within the system. The system may further use its authentication servers to certify the identity of users of the system, such that other users may verify the identity of the certified users. In some embodiments, the entity may certify the identity of the other users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (e.g., rotationally coupled, pivotally coupled, or the like). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

Institutions such as contact centers and technical support centers may rely on conveying and understanding issues between participants to resolve issues presented within an interaction. As the nature and context of an interaction changes on a case-by-case basis, quickly understanding and processing the information within an interaction may provide solutions at a faster rate and decrease time spent per interaction.

Massive amounts of time may be spent by participants to understand and process the intricacies of the interaction. Further, participants within the interaction may not be familiar with the highlights of the interaction (e.g., what aspects are foundational to the issues encountered). Direct access to participants information (e.g., directly accessing a participant's screen) may present difficulties as well, as understanding the interaction would be best understood if shortly conveyed and understood through provided data from the participants of the interaction.

Micro language models may be used to process context data (e.g., data provided by a participant before direct contact between participants is established) to form a concise summary of the nature of the interaction. With the context summary, the second participant of the interaction may gather interaction data through direct communication with the second participant (e.g., an audio messaging system/phone call) that may be processed by a second micro language model to generate an interaction summary. As direct communications between the first and second participant continue, the interaction summary may be adjusted with the incoming data. A set of resolutions and a set of warnings may then be generated using the context summary and the interaction summary to dynamically point out and suggest solutions relevant to the interaction. The summarization and dynamic resolutions and warnings may facilitate resolutions for received interactions.

Accordingly, the present disclosure describes using multiple micro language models within an interaction (e.g., a technical support session) to summarize the context of the interaction and communications within the interaction. A received interaction may be consolidated and analyzed using a first micro language model to summarize the context of the interaction (e.g., summarize the actions performed by a first participant to the second participant). As direct communications between participants of the interaction commence (e.g., a phone call), a second micro language model may monitor and summarize the direct communication (e.g., the interaction summary). The context summary and the interaction summary generated by the multiple micro language models may then be used to generate warnings and solutions to the interaction that may be updated as communications between participants progresses. Components of the interaction may then be highlighted based on the warnings and resolutions generated to conclude the interaction. Further embodiments may include periodically generating the summary of the interaction based on communications between the participants, using previous interactions to generate resolutions and warnings, and categorizing generated warnings and resolutions.

What is more, the present disclosure provides a technical solution to a technical problem. As described herein, the technical problem includes summarizing interactions using pre-interaction context and dynamically responding to incoming interaction data. The technical solution presented herein allows for includes building dynamic application prompts with summarization from interaction data. In particular, includes building dynamic application prompts with summarization from interaction data is an improvement over existing solutions to summarizing interactions using pre-interaction context, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

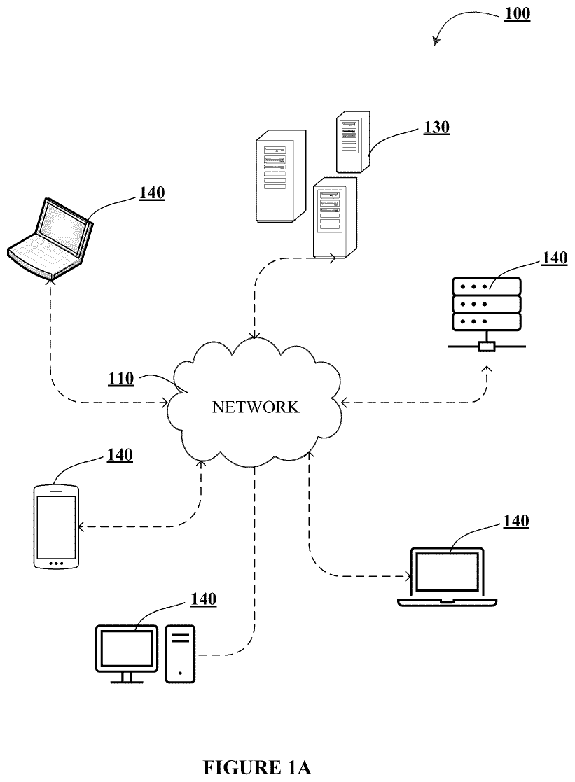

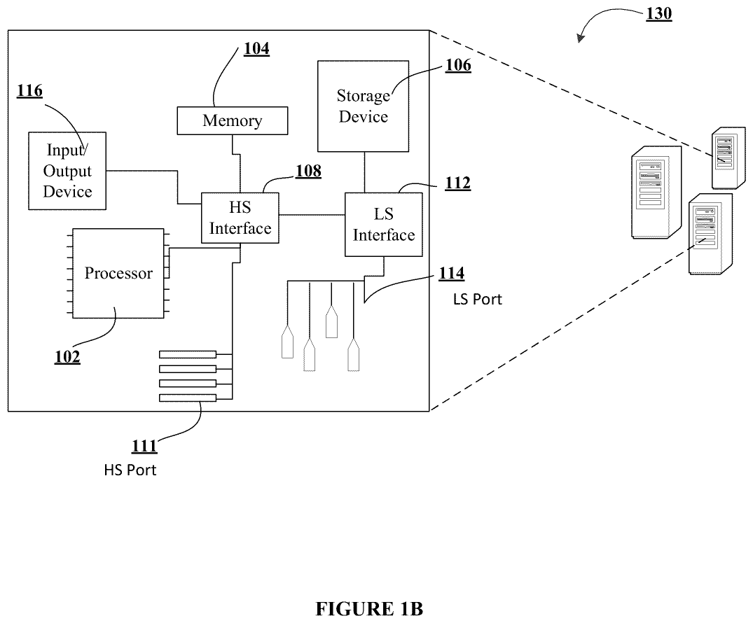

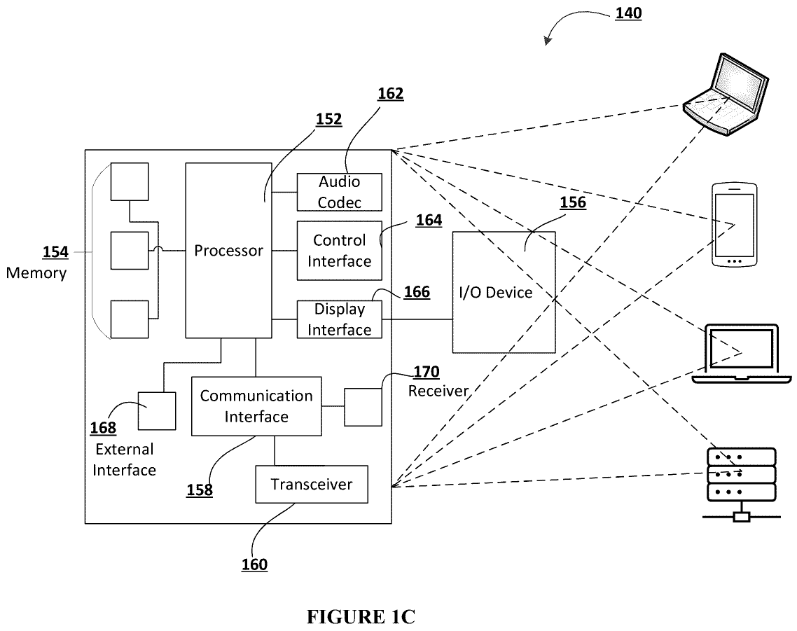

FIGS. 1A-1C illustrate technical components of an exemplary distributed computing environment for building dynamic application prompts within summarization from interaction data 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connected to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which may be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 connecting to low-speed bus 114 and storage device 106. Each of the components 102, 104, 106, 108, 112 and 114 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product may be tangibly embodied in an information carrier. The computer program product may also contain instructions that, when executed, perform one or more methods, such as those described above. The information carrier may be a non-transitory computer- or machine-readable storage medium, such as the memory 104, the storage device 106, or memory on processor 102.

The high-speed interface 108 manages bandwidth-intensive operations for the system 130, while the low-speed interface/controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, the low-speed interface/controller 112 is coupled to storage device 106 and low-speed bus/expansion port 114. The low-speed bus/expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 166 may comprise appropriate circuitry and may be configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 may be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier may be a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through the communication interface 158, which may include digital signal processing circuitry where necessary. The communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, a GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using an audio codec 162, which may receive spoken information from a user and convert the spoken information to usable digital information. The audio codec 162 may likewise generate audible sound for a user, such as through a speaker (e.g., in a handset of end-point device(s) 140). Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described herein may be realized in digital electronic circuitry, integrated circuitry, specially designed ASICs (application specific integrated circuits), computer hardware, firmware, software, and/or combinations thereof.

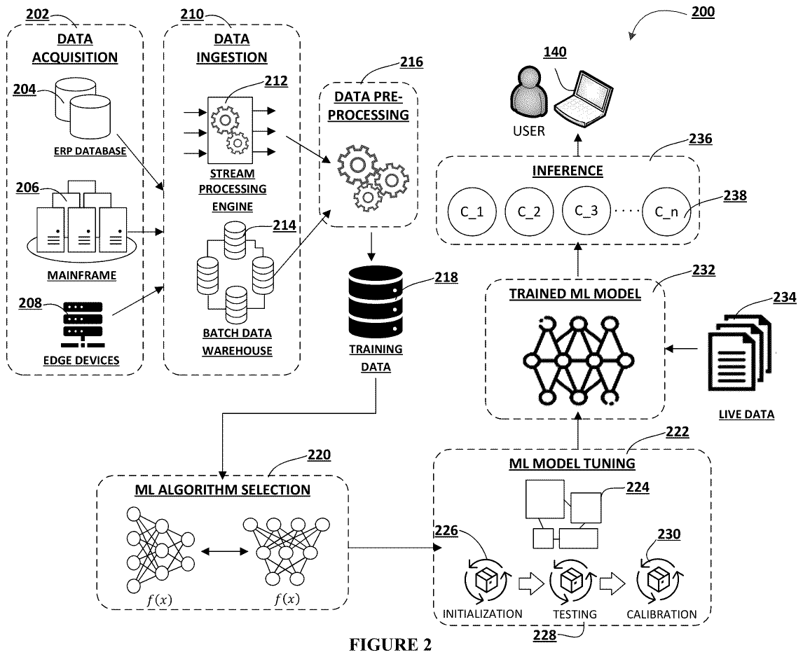

FIG. 2 illustrates an exemplary architecture of a machine learning (ML) subsystem 200, in accordance with an embodiment of the disclosure. The machine learning subsystem 200 may include a data acquisition engine 202, data ingestion engine 210, data pre-processing engine 216, ML model tuning engine 222, and inference engine 236

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and may describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad of Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframes that are often the entity's central data processing center, edge devices that may be any piece of hardware, such as sensors, actuators, gadgets, appliances, or machines, that may be programmed for certain applications and may transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different locations, the data may need to be cleansed and transformed so that it may be analyzed together with data from other sources. At the data ingestion engine 210, the data may be ingested in real-time, using the stream processing engine 212, in batches using the batch data warehouse 214, or in a combination of both. The stream processing engine 212 may be used to process continuous data streams (e.g., data from edge devices) by computing on data directly as it is received, and filtering the incoming data to retain specific portions that are deemed useful by aggregating, analyzing, transforming, and/or ingesting the data. On the other hand, the batch data warehouse 214 may collect and transfer data in batches according to scheduled intervals, triggered events, and/or any other logical ordering.

In machine learning, the quality of data and the useful information that may be derived therefrom, directly affects the ability of the machine learning model 224 to learn. The data pre-processing engine 216 may implement advanced integration and processing steps needed to prepare the data for machine learning execution. This may include modules to perform any upfront data transformations to consolidate the data into alternate forms by changing the value, structure, and/or format of the data by using generalization, normalization, attribute selection, and aggregation, to data clean by filling missing values, smoothing noisy data, resolving inconsistent data, removing outliers, and/or any other encoding steps as needed.

In addition to improving the quality of the data, the data pre-processing engine 216 may implement feature extraction and/or selection techniques to generate training data 218. Feature extraction and/or selection is a process of transforming and/or reducing the data into new features that may better represent underlying patterns in the data. Additionally, or alternatively, feature extraction and/or selection may be a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data may be enriched using one or more meaningful and informative labels to provide context such that a machine learning model may learn from the provided context. For example, labels may indicate whether a photo contains a bird or a car, which words were uttered in an audio recording, or if an x-ray contains a tumor. Data labeling is required for a variety of use cases including computer vision, natural language processing, and speech recognition. In contrast, unsupervised learning may use unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, the type and the size of the data, the available computational time, the number of features and observations in the data, and/or the like. Machine learning algorithms may refer to programs (e.g., math and logic) that may be configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the machine learning model, the ML model tuning engine 222 may repeatedly execute cycles of experimentation including initialization 226, testing 228, and/or calibration 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and whose model accuracy is maximized.

The trained machine learning model 232, similar to any other software application output, may be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C₁, C₂, . . . , Cₙ 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C₁, C₂, . . . , Cₙ 238) live data 234 based on how similar they are to one another to solve exploratory challenges where little may be known about the data, provide a description or label (e.g., C₁, C₂, . . . , Cₙ 238) to live data 234, such as in classification, and/or the like. These categorized outputs, groups (clusters), or labels may then be presented to the user input system 140. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

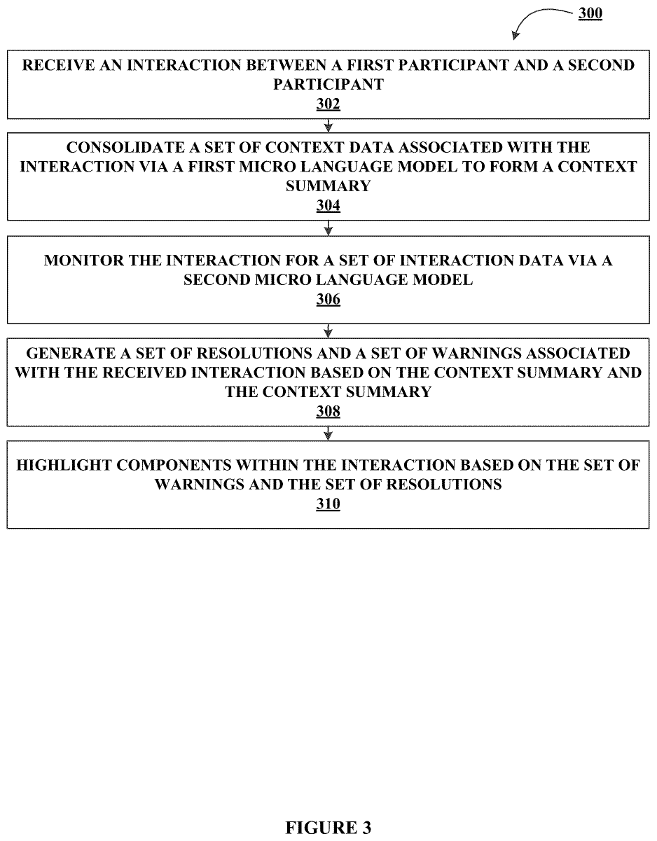

FIG. 3 illustrates a process flow building dynamic application prompts within summarization from interaction data. In some embodiments, a system (e.g., similar to one or more of the systems described herein with respect to FIGS. 1A-1C) and a form of machine learning (e.g., similar to one or more exemplary machine learning subsystem architectures described herein with respect to FIG. 2) may perform one or more of the steps of process flow 300.

As shown in Block 302, the process flow 300 may include the step of receiving an interaction between a first participant and a second participant. The interaction may refer to communication between one or more users, one or more entities or institutions, one or more devices, nodes, clusters, or systems within the distributed computing environment as previously described. In some embodiments, the interaction may be embodied as a query, investigation, call for assistance, and/or incident report (e.g., in some embodiments the interaction may be a call for technical support/technical support session). The interaction may comprise a plurality of communications between the first participant and the second participant. In some embodiments, the interaction may comprise a set of communications between the first participant, the second participant, and entities, users, institutions, devices, and/or systems associated with the first participant or second participant. In other words, the received interaction may be categorized as interaction data between the first and second participants (e.g., interaction data which may be gathered from direct communications between the first participant and the second participant), and context data (e.g., data collected before direct communications between the first participant and the second participant have been established). For instance, the received interaction may be embodied as a set of audio communications (e.g., a phone call) between the first participant, an automated audio messaging program associated with the second participant (e.g., an automated response that records and reacts to requests from the first participant), and the second participant. The received interaction may comprise context data transmitted between the first participant and the automated audio messaging program; and interaction data communicated between the first participant and the second participant (i.e., direct communication between the first and second participant). The received interaction may then be consolidated, summarized, and analyzed using the context data and interaction data as described in greater detail below.

Participants within the interaction may comprise users and/or institutions. Participants within the interaction may comprise a group/plurality which may be considered a participant. For instance, the first participant may comprise a user and the second participant may comprise an entity. In other words, multiple users may represent an entity which may be grouped together as the second participant.

The context data within the received interaction may be consolidated from indirect communications between the first participant and the second participant. For instance, portions of the received interaction transmitted via indirect communication (e.g., interaction summaries of previous interactions, data associated with the current interaction including but not limited to purpose and contents of the interaction) between the first and second participant may be context data. In other words, context data may be data associated with the interaction before direct communication between the first participant and the second participant are established. The first participant may provide the set of context data within the interaction before direct communications are established (e.g., answers to automated prompts, background data regarding the interaction, and data associated with the first participant). The context data provided may then be consolidated, as described in greater detail below.

Interaction data may comprise direct communications between the first participant and the second participant. Interaction data may be continuously produced during the interaction, as communications between the first participant and the second participant are conducted. For instance, a set of audio communications (e.g., a phone call between the first and second participant) may produce interaction data that may be collected and analyzed via micro language models. Collection and consolidation of the interaction data may produce summarizations of the interaction, which may be added to future context data upon conclusion of the interaction as described in greater detail below.

In some embodiments, the interaction may specifically comprise a technical support session initiated by a partner (e.g., the first partner) to address a technical issue with a product or service. This interaction may involve, for example, a phone call, chat session, an email exchange, and/or combination of such with a representative of an institution (e.g., the second partner). During the interaction, information may be exchanged in real time or asynchronously, and may include problem descriptions, diagnostic data, solution steps, and/or follow up actions.

As shown in Block 304, the process flow 300 may include the step of consolidating a set of context data associated with the interaction via a first micro language model to form a pre-interaction summary. The set of context data may be analyzed, consolidated, and/or determined to form a “background” or “environmental context” of the interaction, which may be included within the context summary. The context summary may provide a summarization of the actions, communications, and metadata associated with the interaction and the participants within the interaction before direct communications between the first and second participants have been established. The set of context data may comprise a summary, bullet points, and/or notes regarding the context of the interaction. The context summary may be accessed, read, utilized, and/or referred to by participants within the interaction (e.g., the second participant may reference the context summary to understand the context of the interaction and the first participant). The context summary may be generated via machine learning models, micro language models, and/or artificial intelligence, as described in greater detail below.

A micro language model may refer to a specialized machine learning models as previously described in FIG. 2. The micro language model may be a form of machine learning models as previously described, albeit the micro language model may be trained using domain-specific tasks or constrained computational environments. The micro language models as described may be trained using a subset of training data that may be focused on a set of tasks, objectives, environments, organizational settings, and response types. The micro language models described may utilize structures, systems, and architectures of the machine learning models described. In some embodiments, the micro language models may further be utilized within a secured/tailored environment for the procedures, tasks, and operations described.

As shown in Block 306, the process flow 300 may include the step of monitoring the interaction for a set of interaction data via a second micro language model, wherein the set of interaction data monitored by the second micro language model forms an interaction summary via the second micro language model. Interaction data may be collected throughout the interaction between the first participant and the second participant (i.e., during direct communication between the first participant and the second participant). For instance, as audio messaging/communications are recorded, transcribed, and/or documented during the interaction, the set of interaction data may provide data that may summarize the interaction. As further details and data associated with the interaction are discussed/communicated/addressed between the first participant and the second participant, the set of interaction data may be increased. As collected interaction data is monitored, the interaction summary may be updated, revised, and/or edited upon reception of interaction data. In other words, the set of context data may provide background information of the interaction for the first participant and the second participant, while the interaction data may be current, dynamic data associated with the interaction that is monitored during direct communications between the participants (e.g., monitoring a phone call between the participants for further information regarding the interaction).

The interaction summary generated from monitoring the interaction may comprise notes, recordings, summarizations, bullet points, overviews, and/or condensed summaries of direct communications between the first participant and the second participant. The context summary may provide background information/data regarding the interaction which in some embodiments may be used as a resource for one of the participants to understand the details of the interaction (e.g., the first participant has been providing context data to automated systems during the interaction before direct communication between the participants ahs been established). The interaction summary may be a review of the direct communications between the first participant and the second participant during the interaction (e.g., summary of audio communications between the first participant and the second participant). The interaction summary may be generated via a micro language model separate from the context summary, as described in greater detail below.

As shown in Block 308, the process flow 300 may include the step of generating a set of resolutions and a set of warnings associated with the received interaction based on the context summary and the interaction summary. The set of resolutions and the set of warnings generated from the context summary and the interaction summary. The set of resolutions may comprise potential solutions, actions, and/or recommendations associated with the interaction. For instance, an interaction embodied by a technical support inquiry, the interaction may comprise dynamic recommendations for the interaction by suggesting actions that may resolve an issue/problem. The set of resolutions may be updated from the context summary and the interaction summary that may be ongoing with the interaction. The set of warnings may comprise potential missteps, exposures, weaknesses, and/or future issues within contents of the interaction. In other words, the set of warnings may comprise potential issues based on the context data and interaction data provided. The set of resolutions and the set of warnings associated with the received interaction may be updated as interaction data is monitored, collected, and processed by the second micro language model. Generation of the set of warnings and the set of resolutions may be conducted without direct access to or control over a participant's screen, interface, and/or ability to maintain control over devices associated with the interaction.

As shown in Block 310, the process flow 300 may include the step of highlighting components within the interaction based on the set of warnings and the set of resolutions. The set of resolutions and the set of warnings associated with the received interaction may point to attributes, components, actions, and/or aspects of the interaction that may resolve, protect, and/or complete the interaction. For instance, the interaction embodied as a technical support session may have a set of resolutions that highlight potential solutions to issues presented within the technical support session. Further still, the set of warnings may dictate potential issues found within the technical support session and provide guidance on actions to prevent further issues from arising.

In some embodiments, highlighted components within the interaction are updated on a predetermined periodic basis during the interaction. For instance, interaction data may be collected on a predetermined cycle (e.g., every ten seconds) which may cause a regeneration of the interaction summary. The regeneration of the interaction summary may, in turn, regenerate the set of warnings and the set of resolutions which may highlight different components of the interaction. In some embodiments wherein the interaction embodies a technical support session, the set of warnings and the set of resolutions may be updated/regenerated on a predetermined periodic basis during direct communications between the first participant and the second participant of the interaction. In some embodiments, the interaction summary may be updated on a predetermined periodic basis during the interaction. The interaction summary may be updated on a predetermined periodic basis and may be updated at a separate frequency than the highlighted components update. For instance, the interaction summary may be updated every 5 seconds during the interaction while the highlighted components may be updated every 10 seconds.

In some embodiments, the interaction summary may be added to the set of context data upon conclusion of the interaction. Upon conclusion of the interaction, the interaction summary, the set of warnings, and the set of resolutions generated may be saved as context data for a future interaction. In other words, previously encountered interactions may be attributed with a participant or type of interaction, and resolutions and warnings from the previous interaction may be used to solve future interactions.

In some embodiments, the set of context data may comprise previously conducted interactions, historical requests, and participant actions before the interaction. The set of context data may include previously conducted interactions by a participant (e.g., a returning participant may have previous interactions and the previously generated set of warnings and set of resolutions which may be analyzed and processed) that may be referenced within the current interaction. In some embodiments, the set of interaction data may comprise participant actions conducted after commencement of the interaction.

In some embodiments, the set of resolutions and the set of warnings are categorized into predetermined groups. The set of resolutions may be categorized into resolutions that may be performed by participants (e.g., resolutions that may be performed by the first participant or the second participant), by time to implement (e.g., faster resolutions are recommended first), by relevance to the interaction (e.g., using the interaction summary and the context summary to determine resolutions that apply to the interaction), and by feasibility to implement (e.g., resolutions that may be implemented based on the context summary and/or interaction summary). The set of warnings may be categorized by severity of the warning, components of the interaction that may be affected, source of warnings within the set, type of warnings, impact to the participant, time sensitivity of warnings, and/or actionability.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system to build dynamic application prompts with summarization from interaction data, the system comprising:
a processing device;
a non-transitory storage device containing instructions when executed by the processing device, causes the processing device to perform the steps of:
receive an interaction between a first participant and a second participant;
consolidate a set of context data associated with the interaction via a first micro language model to form a context summary;
monitor the interaction for a set of interaction data via a second micro language model, wherein the set of interaction data monitored by the second micro language model forms an interaction summary via the second micro language model;
generate a set of resolutions and a set of warnings associated with the received interaction based on the context summary and the interaction summary; and
highlight components within the interaction based on the set of warnings and the set of resolutions.

2. The system of claim 1, wherein highlighted components within the interaction are updated on a predetermined periodic basis during the interaction.

3. The system of claim 1, wherein the interaction summary is added to the set of context data upon conclusion of the interaction.

4. The system of claim 1, wherein the set of context data comprises previously conducted interactions, historical requests, and participant actions before the interaction.

5. The system of claim 1, wherein the set of context data within the interaction comprises indirect communications between the first participant and the second participant.

6. The system of claim 1, wherein the set of resolutions and the set of warnings are categorized into predetermined groups.

7. The system of claim 1, wherein the interaction summary is updated on a predetermined periodic basis during the interaction.

8. A computer program product for building dynamic application prompts with summarization from interaction data, the computer program product comprising at least one non-transitory computer-readable medium having computer-readable program code portions embodied therein, the computer-readable program code portions which when executed by a processing device are configured to cause a processor to perform the following operations:
receive an interaction between a first participant and a second participant;
consolidate a set of context data associated with the interaction via a first micro language model to form a context summary;
monitor the interaction for a set of interaction data via a second micro language model, wherein the set of interaction data monitored by the second micro language model forms an interaction summary via the second micro language model;
generate a set of resolutions and a set of warnings associated with the received interaction based on the context summary and the interaction summary; and
highlight components within the interaction based on the set of warnings and the set of resolutions.

9. The computer program product of claim 8, wherein highlighted components within the interaction are updated on a predetermined periodic basis during the interaction.

10. The computer program product of claim 8, wherein the interaction summary is added to the set of context data upon conclusion of the interaction.

11. The computer program product of claim 8, wherein the set of context data comprises previously conducted interactions, historical requests, and participant actions before the interaction.

12. The computer program product of claim 8, wherein the set of context data within the interaction comprises indirect communications between the first participant and the second participant.

13. The computer program product of claim 8, wherein the set of resolutions and the set of warnings are categorized into predetermined groups.

14. The computer program product of claim 8, wherein the interaction summary is updated on a predetermined periodic basis during the interaction.

15. A computer-implemented method for building dynamic application prompts with summarization from interaction data, the method comprising:
receiving an interaction between a first participant and a second participant;
consolidating a set of context data associated with the interaction via a first micro language model to form a context summary;
monitoring the interaction for a set of interaction data via a second micro language model, wherein the set of interaction data monitored by the second micro language model forms an interaction summary via the second micro language model;
generating a set of resolutions and a set of warnings associated with the received interaction based on the context summary and the interaction summary; and
highlighting components within the interaction based on the set of warnings and the set of resolutions.

16. The computer-implemented method of claim 15, wherein highlighted components within the interaction are updated on a predetermined periodic basis during the interaction.

17. The computer-implemented method of claim 15, wherein the interaction summary is added to the set of context data upon conclusion of the interaction.

18. The computer-implemented method of claim 15, wherein the context data comprises previously conducted interactions, historical requests, and participant actions before the interaction.

19. The computer-implemented method of claim 15, wherein the set of context data within the interaction comprises indirect communications between the first participant and the second participant.

20. The computer-implemented method of claim 15, wherein the set of resolutions and the set of warnings are categorized into predetermined groups.
